(19) United States
(12) Patent Application Publication
(10) Pub. No.: US 2025/0173823 A1
(43) Pub. Date: May 29, 2025

(54) INFERENCE APPARATUS AND INFERENCE METHOD

(71) Applicant: NEC Corporation, Tokyo (JP)

(72) Inventor: Kazutoshi HIROSE, Tokyo (JP)

(73) Assignee: NEC Corporation, Tokyo (JP)

(21) Appl. No.: 18/950,291

(22) Filed: Nov. 18, 2024

(30) Foreign Application Priority Data
Nov. 29, 2023 (JP) 2023-201348

(51) Int. Cl. G06T 3/4046

(52) U.S. Cl. CPC G06T 3/4046

(57) ABSTRACT

The resolution prediction unit takes data of a certain resolution as an input and predicts a minimum resolution, among multiple resolution candidates, by which a label of the data can be inferred with a predetermined accuracy, using a first model including multiple layers. The resolution conversion unit converts a resolution of the data to the predicted resolution. The inference unit takes a resolution-converted data as an input and infers a label of the data using a second model including multiple layers and a part of activation output from a given layer in the first model.

### CROSS-REFERENCE TO RELATED APPLICATION

This application is based upon and claims the benefit of priority from the prior Japanese Patent Application No. 2023-201348, filed Nov. 29, 2023, the entire contents of which are incorporated herein by reference.

### BACKGROUND OF THE INVENTION

### Technical Field

This disclosure relates to an inference apparatus, an inference method and an inference program.

### Description of the Related Art

When a neural network model is used to infer the objects in an image, the inference time can be shortened by reducing the resolution (size of the image) of the image. On the other hand, reducing the resolution of the image may reduce inference accuracy.

Non-patent Literature 1 describes a technique for predicting the minimum resolution for a given image that does not degrade inference accuracy, converting the resolution of the given image to the predicted resolution, and inferring objects in the image whose resolution has been converted.

### Non-Patent Literature 1

Mingjian Zhu et al., “Dynamic Resolution Network”, [retrieved Oct. 23, 2023], Internet <URL: https://arxiv.org/pdf/2106.02898.pdf>

### SUMMARY OF THE INVENTION

The technique described in Non-Patent Literature 1 requires a large amount of computation to predict the resolution with respect to a given image. Therefore, it could take a long time to obtain an inference result.

It is also desirable to reduce the time required to infer labels for data even when the given data is one-dimensional data, such as signal data.

Therefore, it is an object of this invention to provide an inference apparatus, an inference method, and an inference program that can predict the resolution with respect to given data, convert the resolution of the given data to the predicted resolution, and reduce the amount of computation in the case of inferring a label for data whose resolution has been converted.

The inference apparatus based on the present disclosure includes a resolution prediction unit which takes data of a certain resolution as an input and predicts a minimum resolution, among multiple resolution candidates, by which a label of the data can be inferred with a predetermined accuracy, using a first model including multiple layers, a resolution conversion unit which converts a resolution of the data to the predicted resolution, and an inference unit which takes a resolution-converted data as an input and infers a label of the data using a second model including multiple layers and a part of activation output from a given layer in the first model.

The inference method based on the present disclosure includes taking data of a certain resolution as an input and predicting a minimum resolution, among multiple resolution candidates, by which a label of the data can be inferred with a predetermined accuracy, using a first model including multiple layers, converting a resolution of the data to the predicted resolution, and taking a resolution-converted data as an input and inferring a label of the data using a second model including multiple layers and a part of activation output from a given layer in the first model.

The inference program based on the present disclosure causes a computer to execute taking data of a certain resolution as an input and predicting a minimum resolution, among multiple resolution candidates, by which a label of the data can be inferred with a predetermined accuracy, using a first model including multiple layers, converting a resolution of the data to the predicted resolution, and taking a resolution-converted data as an input and inferring a label of the data using a second model including multiple layers and a part of activation output from a given layer in the first model.

According to this disclosure, the amount of computation can be reduced when predicting the resolution with respect to given data, converting the resolution of the given data to the predicted resolution, and inferring a label of the data whose resolution has been converted.

### BRIEF DESCRIPTION OF THE DRAWINGS

FIG. 1: It depicts a block diagram showing an example configuration of the inference apparatus of the present disclosure.

FIG. 2: It depicts a schematic diagram showing an example of a provisionally trained second model and a first model with weights copied from the first layer to a given layer in the second model.

FIG. 3: It depicts a schematic diagram showing an example of the second model with half of the weights of the copy source removed.

FIG. 4: It depicts a schematic diagram showing an example of activations obtained when the resolution prediction unit predicts the resolution.

FIG. 5: It depicts a schematic diagram showing an example of size conversion of the activation 62 when the largest image is input to the inference unit and when the smallest image is input to the inference unit, and a concatenation of the activation 62 after size conversion with the activation output from a given layer 54a.

FIG. 6: It depicts a flowchart showing an example of the processing process of the inference apparatus of the present disclosure.

FIG. 7: It depicts a block diagram showing an example configuration of the inference apparatus of the present disclosure.

FIG. 8: It depicts a schematic diagram showing an example of a concatenation when the largest image is input to the inference unit and when the smallest image is input to the inference unit.

FIG. 9: It depicts a flowchart showing an example of the processing process of the inference apparatus of the present disclosure.

FIG. 10: It depicts a flowchart showing an example of the processing process of obtaining the first and second models by training.

FIG. 11: It depicts a block diagram showing an outline block diagram showing a configuration example of a computer related to the inference apparatus of the present disclosure.

FIG. 12: It depicts a block diagram showing an overview of the inference apparatus of the present disclosure.

### DESCRIPTION OF THE PREFERRED EMBODIMENTS

Hereinafter, an example embodiment of the present disclosure will be explained with reference to the drawings. In each of the following example embodiments, the case in which an image is input to the inference apparatus as input data will be used as an example. However, input data is not limited to an image. One-dimensional data such as signal data may also be input to the inference apparatus. The inference apparatus infers a label of the input data.

### Example Embodiment 1

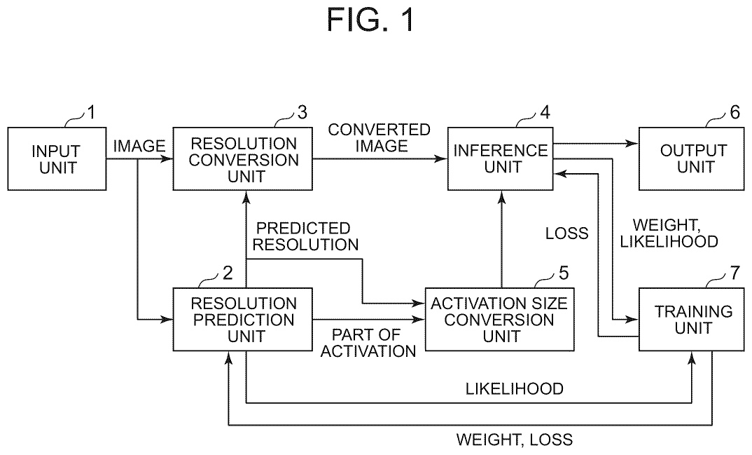

FIG. 1 is a block diagram showing an example configuration of the inference apparatus of the present disclosure. The inference apparatus of this disclosure comprises an input unit 1, a resolution prediction unit 2, a resolution conversion unit 3, an inference unit 4, an activation size conversion unit 5, an output unit 6, and a training unit 7.

Input unit 1 is an input interface to which an image of a certain resolution is input. For example, the input unit 1 is realized by a data reading device that reads images of a certain resolution recorded on a data recording medium. However, the input unit 1 is not limited to such data reading device.

An image of a certain resolution is input to the resolution prediction unit 2 through the input unit 1. The resolution prediction unit 2 inputs an image of a certain resolution, and predicts the minimum resolution, among a plurality of candidate resolutions, at which an object in the image can be inferred with a predetermined accuracy, using a first model including a plurality of layers. The number of a plurality of candidate resolutions is three, for example, but is not limited to three. Each candidate resolution is less than or equal to the resolution of the input image.

The first model is maintained in the resolution prediction unit 2. The first model is a neural network model, for example.

The resolution conversion unit 3 converts a resolution of an image input through the input unit 1 to a resolution predicted by the resolution prediction unit 2.

The inference unit 4 inputs the resolution-converted image and infers an object in the image using a second model that includes multiple layers. In this case, the inference unit 4 infers an object in the image using a part of the activation output from any layer in the first model. It can be said that inferring an object in the image means inferring a label of the image.

The data output from the individual layers of the model is called an activation. The activation is the channel, height (hereinafter, denoted by h), and width (hereinafter, denoted by w). In the drawings, the channel is described as “ch”. When the input data is 1-dimensional data, one of h and w is a fixed value of “1”.

The second model is maintained in the inference unit 4. The second model is a neural network model, for example.

The first layer to a given layer in the second model corresponds to the first layer to a given layer in the first model.

When training the second model and the first model, the training unit 7 first tentatively trains the second model. Then, the training unit 7 copies the weights from the first layer to the given layer in the second model to from the first layer to the given layer in the first model. Among the weights of the copy source, weights corresponding to a part of the percentage of the activation output from a given layer in the first model described above are removed from the second model. The following explanation is based on an example of a case in which a part of the activation output from a given layer in the first model is half of the activation output from a given layer in the first model. However, it is not limited to this example. In this case, half of the weights from the first layer to the given layer are removed from the weights of the copy source. The percentage corresponding to a part of the activation output from any layer in the first model is predetermined.

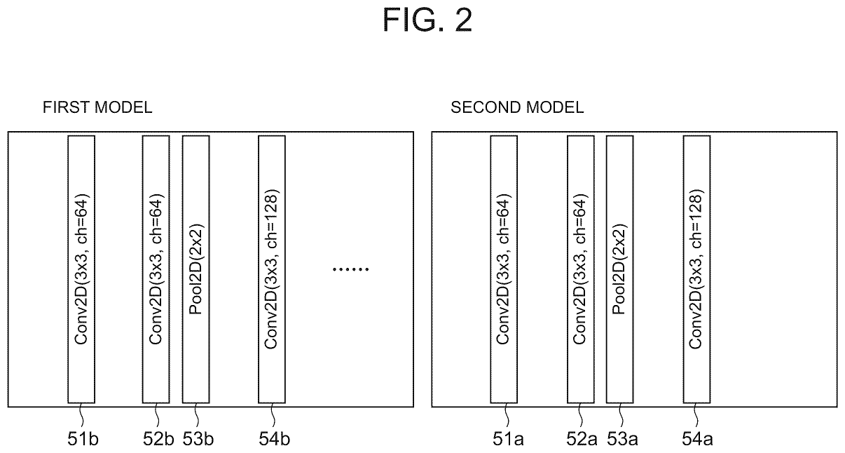

FIG. 2 is a schematic diagram showing an example of a provisionally trained second model and a first model with weights copied from the first layer to a given layer in the second model. The layer 51a and the layer 51b are top layers, and the layer 54a and the layer 54b are the given layers. The layers 51a-54a correspond to the layers 51b-54b, respectively.

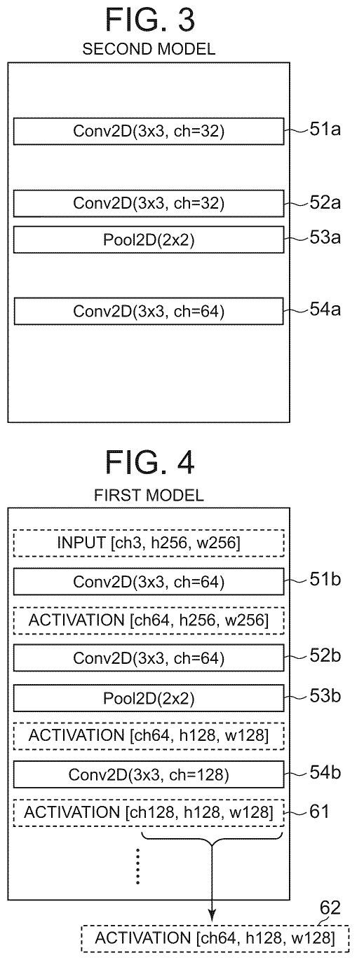

FIG. 3 is a schematic diagram showing an example of the second model with half of the weights of the copy source removed. Since half of the weights of the copy source have been removed, the number of channels in layers 51a, 52a, and 54a shown in FIG. 3 is half the number of channels in layers 51a, 52a, and 54a shown in FIG. 2, respectively.

In the first model, the weights of the layers after the given layer 54b are determined randomly.

This state is the initial state of the first model, and the training unit 7 trains the first and second models. These points are the same in the second example embodiment described below. This training (training by the training unit 7) is described below.

Hereinafter, the explanation will be given assuming that the first model and the second model have been trained. For convenience, the first model after training and the second model after training will also be described by adding codes 51a-54a and 51b-54b to the layers.

The last in the second model is one or more fully-connected layers, and the GlobalAveragePooling layer is provided before that the group of fully-connected layers. As a result, even if resolutions of images input to the second model are not constant, the inference unit 4 can derive an inference result for images of each resolution.

Hereinafter, the inference operation inferring an object in the image by the inference unit 4 using a part (half) of the activation output from any layer in the first model will be explained.

FIG. 4 is a schematic diagram showing an example of activations obtained when the resolution prediction unit 2 predicts the resolution. In the drawings, layers are shown as solid lines and inputs and activations are shown as dashed lines (see FIG. 4).

From a given layer 54b, an activation 61 is output. It is assumed that a part (half) of the activation 61 is used by the inference section 4. The number of channels of the activation 62 (half of the activation 61) used in the inference unit 4 is half the number of channels of the activation 61 (see FIG. 4).

The inference unit 4 concatenates the activation output from the given layer 54a in the second model corresponding to the given layer 54b and the above activation 62 (see FIG. 4) in the channel direction.

However, in order to concatenate the activations in the channel direction, h and w are required to match each other.

The size of the activation output from each layer in the second model varies with the resolution of the image input to the inference unit 4. In this example, when the size of the image (resolution) is the largest, it is assumed that h=256 and w=256. When the size of the image (resolution) is smallest, it is assumed that h=64 and w=64.

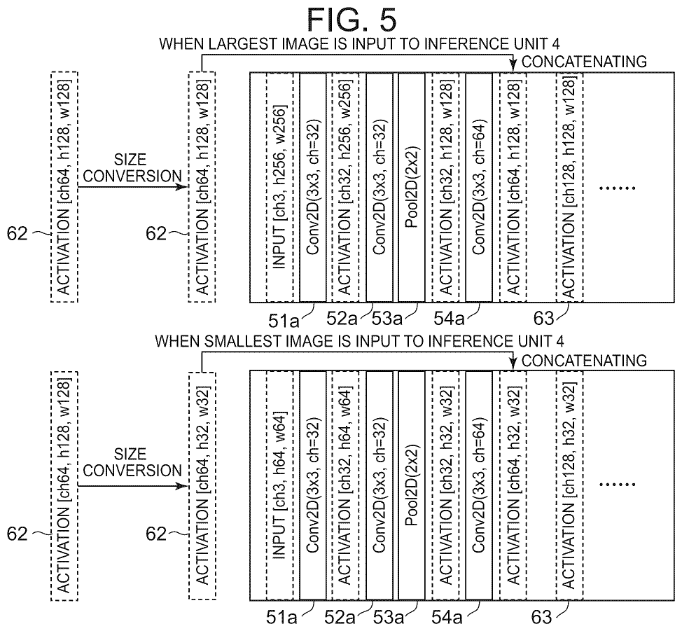

FIG. 5 is a schematic diagram showing an example of size conversion of the activation 62 when the largest image is input to the inference unit 4 and when the smallest image is input to the inference unit 4, and concatenating of the activation 62 after size conversion with the activation output from a given layer 54a.

In the activation output from a given layer 54a in the case where the largest image is input to the inference unit 4, h=128, w=128 (see the upper part of FIG. 5). In this case, the activation size conversion unit 5 converts the size of the activation 62 (half of the activation 61) to its original size (h=128, w=128) (see the upper part of FIG. 5). In other words, the activation size conversion unit 5 does not convert the size of the activation 62.

In the activation output from a given layer 54a in the case where the smallest image is input to the inference unit 4, h=32, w=32 (see the lower part of FIG. 5). In this case, the activation size conversion unit 5 converts the size of the activation 62 (half of the activation 61) to h=32, w=32 (see the lower part of FIG. 5).

In this way, the activation size conversion unit 5 converts the size of the activation 62 (half of the activation 61) according to the resolution predicted by the resolution prediction unit 2 (in other words, the resolution after conversion by the resolution conversion unit 3). However, the resolution conversion unit 3 does not change the number of channels of the activation 62.

Since the activation size conversion unit 5 converts the size of the activation 62, the activation 62 after size conversion can be concatenated in the channel direction with the activation output from the given layer 54a in the second model corresponding to the given layer 54b. The inference unit 4 concatenates the activation 62 after size conversion and the activation output from the given layer 54a in the channel direction, and inputs the concatenation result 63 (see FIG. 5) to the next layer in the second model (the layer next to the given layer 54a). The inference unit 4 then repeats inputting the output of the layer into the next layer to obtain the inference result.

The output unit 6 outputs the inference result obtained by inference unit 4. For example, the output unit 6 displays the inference result on a display device (not shown in FIG. 1) in the inference apparatus. However, the output unit 6 may output the inference result in a form other than display.

The resolution prediction unit 2, the resolution conversion unit 3, the activation size conversion unit 5, the inference unit 4, the output unit 6, and the training unit 7 are realized by a central processing unit (CPU) of a computer operating according to an inference program, for example. In this case, the CPU can read the inference program from a program storage medium such as a program storage apparatus or the like of the computer and operate as the resolution prediction unit 2, the resolution conversion unit 3, the activation size conversion unit 5, the inference unit 4, the output unit 6, and the training unit 7 according to the inference program.

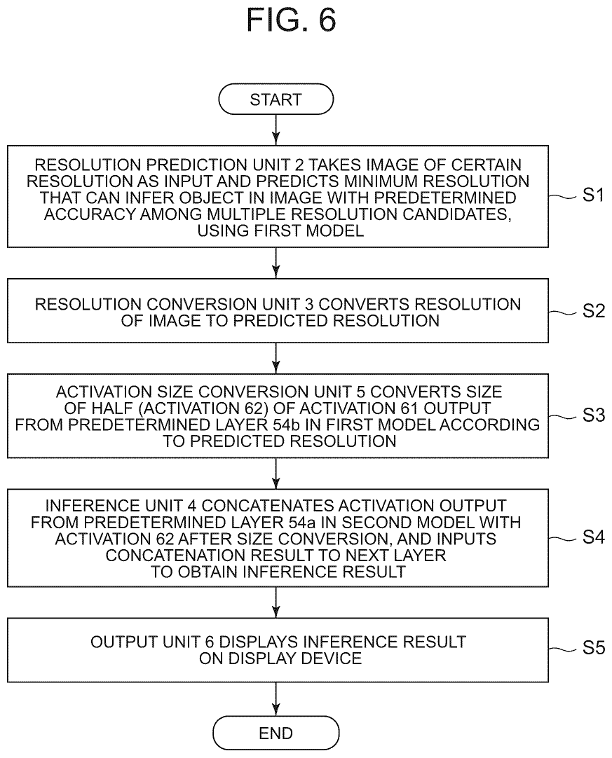

Next, a processing process will be described. FIG. 6 is a flowchart showing an example of the processing process of the inference apparatus of the present disclosure. Matters that have already been explained are omitted as appropriate.

First, the resolution prediction unit 2 takes an image of a certain resolution as input and predicts the minimum resolution, among multiple resolution candidates, by which an object in the image can be inferred with a predetermined accuracy, using the first model (step S1).

Next, the resolution conversion unit 3 converts a resolution of the image to the predicted resolution (step S2).

The activation size conversion unit 5 converts the size of half (activation 62) of the activation 61 output from the given layer 54b in the first model according to the predicted resolution (step S3).

Then, the inference unit 4 concatenates the activation output from the given layer 54a in the second model and the activation 62 after size conversion, and inputs the concatenation result to the next layer. The inference unit 4 repeats inputting the output of the layer into the next layer to obtain the inference result (step S4).

The output unit 6 then displays the inference result on a display device (not shown in FIG. 1) (step S5).

According to this example embodiment, some of the weights copied in the first model are removed in the second model, and then the second model is trained. Therefore, the amount of weight removed reduces an amount of computation when the inference unit 4 uses the second model for inference. Even though the weights are removed, the inference unit 4 still performs inference using the activation 62 (half of the activation 61 output from the given layer 54b in the first model) corresponding to the result of the calculation using the weights. Specifically, the inference unit 4 concatenates, in the channel direction, the activation 62 and the activation output from the given layer 54a in the second mode, and then performs an inference calculation. Therefore, an appropriate inference result can be obtained while reducing the amount of computation.

### Example Embodiment 2

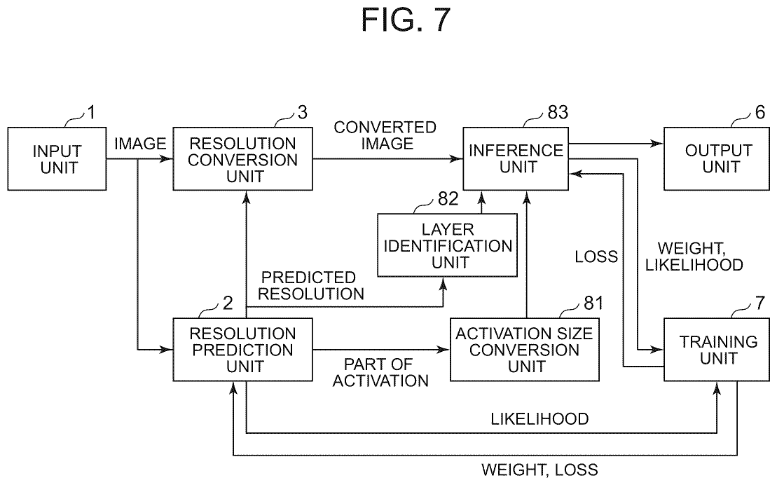

FIG. 7 is a block diagram showing an example configuration of the inference apparatus of the present disclosure. The inference apparatus for this disclosure has an input unit 1, a resolution prediction unit 2, a resolution conversion unit 3, an activation size conversion unit 81, a layer identification unit 82, an inference unit 83, an output unit 6, and a training unit 7.

The input unit 1, the resolution prediction unit 2, the resolution conversion unit 3, the output unit 6, and the training unit 7 are the same as the input unit 1, the resolution prediction unit 2, the resolution conversion unit 3, the output unit 6, and the training unit 7 in the first example embodiment, and detailed descriptions are omitted. The training by the training unit 7 is described below.

The activation size conversion unit 81 converts the size of the activation 62 (see FIG. 4), which corresponds to a part (half) of the activation 61 output from the given layer 54b in the first model, to a certain size according to the minimum resolution among the multiple resolution candidates in the resolution prediction unit 2.

Specifically, the activation size conversion unit 81 converts the size of the activation 62 so that it has the same h and w as the h and w of the activation output from the given layer 54a when an image with the minimum resolution among multiple resolution candidates is input to the second model. The activation size conversion unit 81 does not change the number of channels in the activation 62. In this example, it is assumed that the activation size conversion unit 81 converts the size of the activation 62 from [number of channels 64, h=128, w=128] to [number of channels 64, h=32, w=32].

The layer identification unit 82 identifies the layer, in the second model, which outputs an activation that can be concatenated in the channel direction with the activation 62 after size conversion, based on the resolution predicted by the resolution prediction unit 2 (in other words, a resolution after conversion by the resolution conversion unit 3).

Specifically, the layer identification unit 82 identifies the layer which outputs an activation that has the same h and w, respectively, as the activation 62 after size conversion, when an image with the resolution predicted by the resolution prediction unit 2 is input to the second model.

The inference unit 83 infers an object in the image using the activation 62 that corresponds to a part (half in this example) of the activation 61 output from the given layer 54b in the first model.

In the second example embodiment, the inference unit 83 concatenates the activation output from the layer identified by the layer identification unit 82 and the activation 62 after size conversion in the channel direction and inputs the concatenation result to the next layer in the second model.

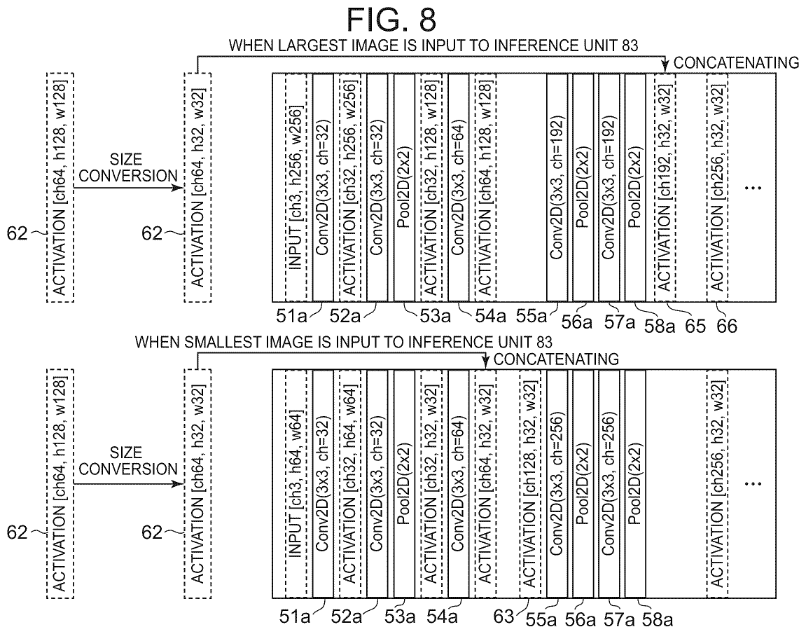

FIG. 8 is a schematic diagram showing an example of concatenating when the largest image is input to the inference unit 83 and when the smallest image is input to the inference unit 83.

When the smallest image is input to the inference unit 83, the layer identification unit 82 identifies the layer 54a as a given layer. Accordingly, the inference unit 83 concatenates the activation output from the given layer 54a and the activation 62 after size conversion in the channel direction, and inputs the concatenation result 63 to the next layer 55a (see the lower part of FIG. 8). The inference unit 83 then repeats inputting the output of the layer into the next layer to obtain the inference result. In FIG. 8, layers 55a-58a after layer 54a are also illustrated. The number of channels in layers 55a and 57a is 256 (see the bottom row of FIG. 8).

When the largest image is input to the inference unit 83, the layer identification unit 82 identifies layer 58a, which outputs the activation 65 with h=32 and w=32. Accordingly, the inference unit 83 concatenates the activation 65 output from layer 58a and the activation 62 after size conversion in the channel direction, and inputs the concatenation result 66 to the next layer (the next layer to the layer 58a) (see the upper part of FIG. 8). The inference unit 83 then repeats inputting the output of the layer to the next layer to obtain the inference result.

As mentioned above, the number of channel of the layer 55a and the number of channel of the layer 57a are 256 (see the lower part of FIG. 8). In the upper part of FIG. 8, the number of channels in the layer 55a and the layer 57a is shown as 192, meaning that 192 channels out of 256 channels are used. Therefore, when the largest image is input to the inference unit 83, operations for 256−192=64 channels are not performed in the layer 55a and the layer 57a. This not performed operation is compensated for by the activation 62 after size conversion, which is concatenated with the activation 65. In this example, the computational complexity is also reduced by the fact that 64 channels of operations are not performed.

The resolution prediction unit 2, the resolution conversion unit 3, the activation size conversion unit 81, the layer identification unit 82, the inference unit 83, the output unit 6, and the training unit 7 are realized by a CPU (Central Processing Unit) of a computer operating according to an inference program, for example. In this case, the CPU can read the inference program from a program storage medium such as a program storage apparatus or the like of the computer and operate as the resolution prediction unit 2, the resolution conversion unit 3, the activation size conversion unit 81, the layer identification unit 82, the inference unit 83, the output unit 6, and the training unit 7 according to the inference program.

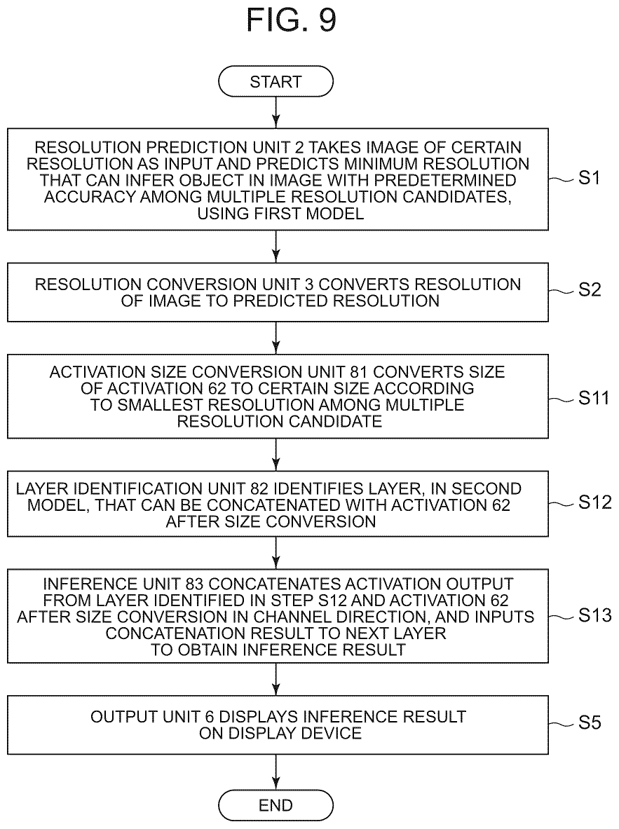

Next, a processing process will be described. FIG. 9 is a flowchart showing an example of the processing process of the inference apparatus of the present disclosure. Matters that have already been explained are omitted as appropriate.

First, the inference apparatus performs steps S1 and S2. Since steps S1 and S2 are the same process as steps S1 and S2 shown in FIG. 6, the explanation is omitted.

Next to step S2, the activation size conversion unit 81 converts the size of the activation 62 to a certain size according to the minimum resolution among the multiple resolution candidates (step S11).

Next, the layer identification unit 82 identifies the layer, in the second model, that can be concatenated with the activation 62 after size conversion (step S12).

Then, the inference unit 83 concatenates an activation output from the layer identified in step S12 and the activation 62 after size conversion in the channel direction, and inputs the concatenation result to the next layer. The inference unit 83 repeats inputting the output of the layer to the next layer to obtain the inference result (step S13).

The output unit 6 then displays the inference result on a display device (not shown in FIG. 7) (step S5). Step S5 is the same process as step S5 shown in FIG. 6.

In the second example embodiment, as in the first example embodiment, appropriate inference result can be obtained while reducing the amount of computation. In addition, as mentioned above, a case can arise in which no calculation is performed for a channel even if it exists as a channel. In this case, the amount of computation can be further reduced.

Next, an operation of obtaining the first and second models in the first and second example embodiments by training will be explained.

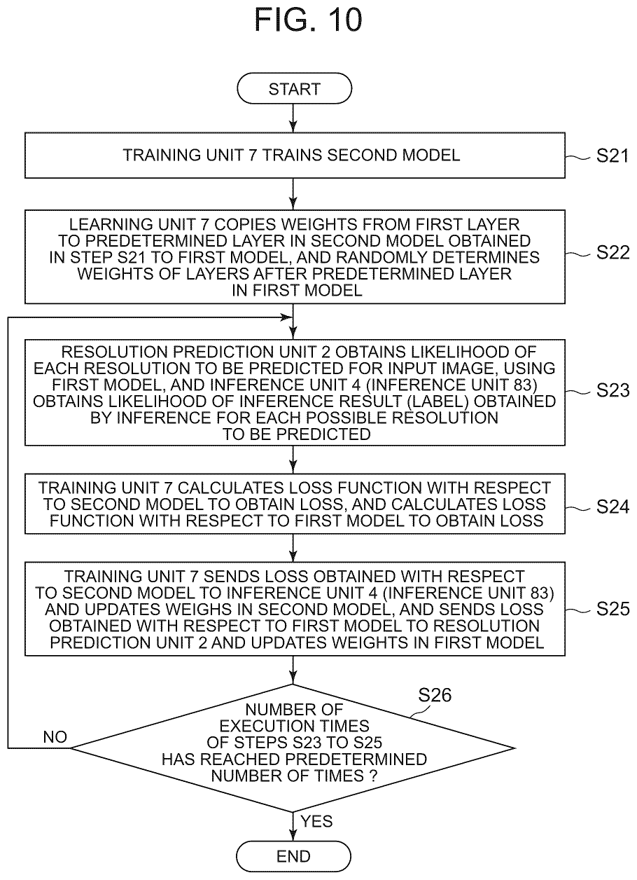

FIG. 10 is a flowchart showing an example of the processing process of obtaining the first and second models by training.

First, the training unit 7 trains a second model (step S21). The second model obtained in step S21 is a tentative second model.

Instead of step S21, a second model that has already been trained may be prepared.

Next, the training unit 7 copies the weights from the first layer to the given layer in the second model obtained in step S21 to the first model, and randomly determines weights of the layers after the given layer in the first model (step S22). The weights in the first model determined in step S22 are initial values of weight in the first model.

Next, the resolution prediction unit 2 obtains likelihood of each resolution to be predicted for the input image, using the first model. The inference unit 4 (the inference unit 83) obtains likelihood of the inference result (label) obtained by inference for each possible resolution to be predicted (step S23), using the second model. The resolution prediction unit 2 sends each obtained likelihood to the training unit 7. The inference unit 4 (the inference unit 83) sends each obtained likelihood to the training unit 7.

Then, the training unit 7 calculates a loss function with respect to the second model to obtain a loss. The training unit 7 also calculates a loss function with respect to the first model to obtain a loss (step S24).

When obtaining the loss function with respect to the second model, the training unit 7 uses a label of an input image as teacher data. When obtaining the loss function with respect to the first model, the training unit 7 uses “a value calculated using a loss of the inference unit 4 (the inference unit 83) and a computation amount of the inference unit 4 (the inference unit 83)” at each resolution that can be predicted as the teacher data. For example, “a loss of the inference unit 4 (the inference unit 83)+λ*computation amount of the inference unit 4 (the inference unit 83)” is used as the teacher data. λ is a predetermined constant. To reduce the computation amount, the value of 2 should be set to a large value. When the inference accuracy is to be maintained, the value of λ should be set to a small value.

The training unit 7 sends the loss obtained with respect to the second model to the inference unit 4 (the inference unit 83) and updates the weighs in the second model. The training unit 7 also sends the loss obtained with respect to the first model to the resolution prediction unit 2 and updates the weights in the first model (step S25).

Next, the training unit 7 determines whether the number of execution times of steps S23 to S25 has reached a predetermined number of times (step S26). When the number of execution times of steps S23 to S25 has not reached the predetermined number of times (No in step S26), step S23 and subsequent operations are repeated.

When the number of execution times of steps S23 to S25 reaches the predetermined number of times (Yes in step S26), the training unit 7 determines the first and second models at that point as the finalized first and second models, respectively, and terminates the process.

In this way, the first model is a model trained with a state such that the weights from the first layer to the given layer are the same as the weights from the first layer to the given layer of the second model as the initial state.

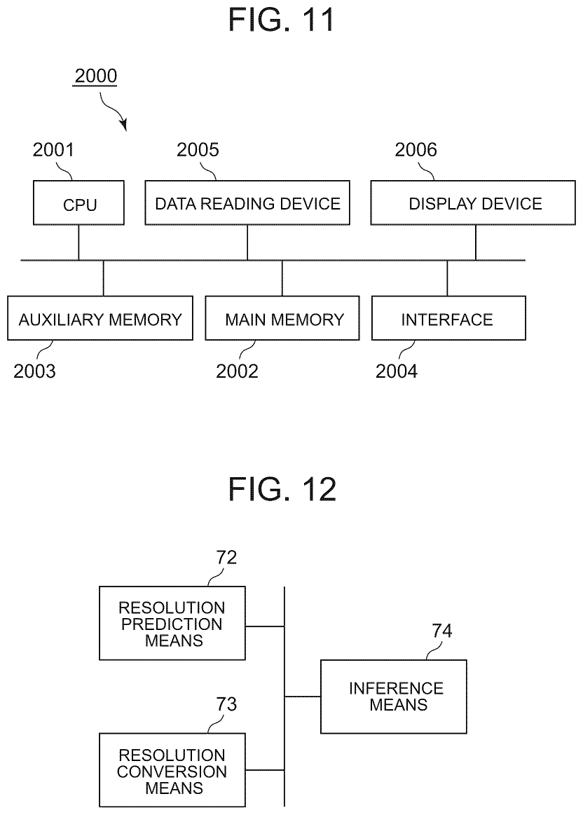

FIG. 11 is a block diagram showing an outline block diagram showing a configuration example of a computer related to the inference apparatus of the present disclosure. The computer 2000 comprises a CPU 2001, a main memory 2002, an auxiliary memory 2003, an interface 2004, a data reading device 2005, and a display device 2006, for example. However, the configuration of the computer 2000 is not limited to the example shown in FIG. 11.

The inference apparatus of the present disclosure is realized by the computer 2000, for example. The operation of the inference apparatus is stored in the auxiliary memory 2003 in a form of a program (inference program). The CPU 2001 loads the program from auxiliary memory 2003 into main memory 2002, and, according to the program, performs the processing described in each example embodiment above.

The auxiliary storage apparatus 2003 is an example of a non-temporary tangible medium. Other examples of non-transitory tangible media include a magnetic disk, an magneto-optical disk, a CD-ROM (Compact Disk Read Only Memory), DVD-ROM (Digital Versatile Disk Read Only Memory), DVD-ROM (Digital Disk Read Only Memory), a semiconductor memory, etc., connected through interface 2004.

The inference apparatus may be realized by a plurality of computers that are communicatively connected.

Next, an overview of the inference apparatus for this disclosure is described. FIG. 12 is a block diagram showing an overview of the inference apparatus for this disclosure. The inference apparatus comprises resolution prediction means 72, resolution conversion means 73, and inference means 74.

The resolution prediction means 72 (for example, the resolution prediction unit 2) takes data of a certain resolution as an input and uses a first model including multiple layers to predict a minimum resolution among multiple resolution candidates that can infer the label of the data with a predetermined accuracy.

The resolution conversion means 73 (for example, the resolution conversion unit 3) converts a resolution of the data to the predicted resolution.

The inference means 74 (for example, the inference unit 4, the inference unit 83) takes a resolution-converted data as an input and infers a label of the data using a second model including multiple layers. The inference means 74 infers the label of the data using a part of activation output from a given layer in the first model.

Such a configuration reduces an amount of computation when predicting the resolution with respect to given data, converting a resolution of the given data to the predicted resolution, and inferring the label of the data whose resolution has been converted.

A part of or all of the above example embodiments may also be described as, but not limited to, the following supplementary notes.

### Supplementary Note 1

An inference apparatus comprising:
a memory that stores software instructions, and
one or more processors configured to execute the software instructions to
take data of a certain resolution as an input and predict a minimum resolution, among multiple resolution candidates, by which a label of the data can be inferred with a predetermined accuracy, using a first model including multiple layers,
convert a resolution of the data to the predicted resolution, and
take a resolution-converted data as an input and infer a label of the data using a second model including multiple layers and a part of activation output from a given layer in the first model.

### Supplementary Note 2

The inference apparatus according to Supplementary note 1, wherein
the one or more processors configured to execute the software instructions to
convert a size of the part of activation according to the predicted resolution, and
when performing inference, concatenate, in a channel direction, an activation output from a layer in the second model corresponding to the given layer and the part of activation after size conversion, and input concatenation result to a next layer in the second model.

### Supplementary Note 3

The inference apparatus according to Supplementary note 1, wherein
the one or more processors configured to execute the software instructions to
convert a size of the part of activation to a certain size according to the minimum resolution among the multiple resolution candidates,
identify a layer, in the second model, which outputs an activation that can be concatenated with the part of activation after size conversion, and
when performing inference, concatenate, in a channel direction, an activation output from the identified layer and the part of activation after size conversion, and input concatenation result to a next layer in the second model.

### Supplementary Note 4

The inference apparatus according to Supplementary note 1, wherein
the first model is a model trained with a state such that weights from a first layer to the given layer are the same as weights from a first layer to the given layer of the second model as an initial state.

### Supplementary Note 5

An inference method implemented by a computer, comprising:
taking data of a certain resolution as an input and predicting a minimum resolution, among multiple resolution candidates, by which a label of the data can be inferred with a predetermined accuracy, using a first model including multiple layers,
converting a resolution of the data to the predicted resolution, and
taking a resolution-converted data as an input and inferring a label of the data using a second model including multiple layers and a part of activation output from a given layer in the first model.

### Supplementary Note 6

The inference method according to Supplementary note 5, further comprising
converting a size of the part of activation according to the predicted resolution, and
when performing inference, concatenating, in a channel direction, an activation output from a layer in the second model corresponding to the given layer and the part of activation after size conversion, and inputting concatenation result to a next layer in the second model.

### Supplementary Note 7

The inference method according to Supplementary note 5, further comprising
converting a size of the part of activation to a certain size according to the minimum resolution among the multiple resolution candidates,
identifying a layer, in the second model, which outputs an activation that can be concatenated with the part of activation after size conversion, and
when performing inference, concatenating, in a channel direction, an activation output from the identified layer and the part of activation after size conversion, and inputting concatenation result to a next layer in the second model.

### Supplementary Note 8

An inference program causing a computer to execute:
taking data of a certain resolution as an input and predicting a minimum resolution, among multiple resolution candidates, by which a label of the data can be inferred with a predetermined accuracy, using a first model including multiple layers,
converting a resolution of the data to the predicted resolution, and
taking a resolution-converted data as an input and inferring a label of the data using a second model including multiple layers and a part of activation output from a given layer in the first model.

Some or all of the configurations described in Supplementary notes 2 to 4, which are dependent on Supplementary note 1 described above, can be dependent on Supplementary notes 5 and 6 by the same dependency relationship as Supplementary notes 2 to 4. Furthermore, not limited to Supplementary note 1, Supplementary note 5 and Supplementary note 6, some or all of the configurations described as Supplementary notes can similarly depend on various hardware, software, various recording means for recording software, or systems, to the extent not deviating from each example embodiment described above.

Although the present disclosure has been described above with reference to example embodiments, the present disclosure is not limited to the above example embodiments. Various changes can be made to the configuration and details of the present disclosure that can be understood by those skilled in the art within the scope of the present disclosure.

### INDUSTRIAL APPLICABILITY

The present invention is suitable for an inference apparatus that infers an object or objects in an image.

What is claimed is:

1. An inference apparatus comprising:
a memory that stores software instructions, and
one or more processors configured to execute the software instructions to
take data of a certain resolution as an input and predict a minimum resolution, among multiple resolution candidates, by which a label of the data can be inferred with a predetermined accuracy, using a first model including multiple layers,
convert a resolution of the data to the predicted resolution, and
take a resolution-converted data as an input and infer a label of the data using a second model including multiple layers and a part of activation output from a given layer in the first model.

2. The inference apparatus according to claim 1, wherein
the one or more processors configured to execute the software instructions to
convert a size of the part of activation according to the predicted resolution, and
when performing inference, concatenate, in a channel direction, an activation output from a layer in the second model corresponding to the given layer and the part of activation after size conversion, and input concatenation result to a next layer in the second model.

3. The inference apparatus according to claim 1, wherein
the one or more processors configured to execute the software instructions to
convert a size of the part of activation to a certain size according to the minimum resolution among the multiple resolution candidates,
identify a layer, in the second model, which outputs an activation that can be concatenated with the part of activation after size conversion, and
when performing inference, concatenate, in a channel direction, an activation output from the identified layer and the part of activation after size conversion, and input concatenation result to a next layer in the second model.

4. The inference apparatus according to claim 1, wherein
the first model is a model trained with a state such that weights from a first layer to the given layer are the same as weights from a first layer to the given layer of the second model as an initial state.

5. The inference apparatus according to claim 2, wherein
the first model is a model trained with a state such that weights from a first layer to the given layer are the same as weights from a first layer to the given layer of the second model as an initial state.

6. The inference apparatus according to claim 3, wherein
the first model is a model trained with a state such that weights from a first layer to the given layer are the same as weights from a first layer to the given layer of the second model as an initial state.

7. An inference method implemented by a computer, comprising:
taking data of a certain resolution as an input and predicting a minimum resolution, among multiple resolution candidates, by which a label of the data can be inferred with a predetermined accuracy, using a first model including multiple layers,
converting a resolution of the data to the predicted resolution, and
taking a resolution-converted data as an input and inferring a label of the data using a second model including multiple layers and a part of activation output from a given layer in the first model.

8. The inference method according to claim 7, further comprising
converting a size of the part of activation according to the predicted resolution, and
when performing inference, concatenating, in a channel direction, an activation output from a layer in the second model corresponding to the given layer and the part of activation after size conversion, and inputting concatenation result to a next layer in the second model.

9. The inference method according to claim 7, further comprising
converting a size of the part of activation to a certain size according to the minimum resolution among the multiple resolution candidates,
identifying a layer, in the second model, which outputs an activation that can be concatenated with the part of activation after size conversion, and
when performing inference, concatenating, in a channel direction, an activation output from the identified layer and the part of activation after size conversion, and inputting concatenation result to a next layer in the second model.

10. A non-transitory computer readable recording medium storing an inference program which, when executed by a processor, performs:
taking data of a certain resolution as an input and predicting a minimum resolution, among multiple resolution candidates, by which a label of the data can be inferred with a predetermined accuracy, using a first model including multiple layers,
converting a resolution of the data to the predicted resolution, and
taking a resolution-converted data as an input and inferring a label of the data using a second model including multiple layers and a part of activation output from a given layer in the first model.

11. The non-transitory computer readable recording medium according to claim 10, wherein
the inference program, when executed by a processor, performs
converting a size of the part of activation according to the predicted resolution, and
when performing inference, concatenating, in a channel direction, an activation output from a layer in the second model corresponding to the given layer and the part of activation after size conversion, and inputting concatenation result to a next layer in the second model.

12. The non-transitory computer readable recording medium according to claim 10, wherein
the inference program, when executed by a processor, performs
converting a size of the part of activation to a certain size according to the minimum resolution among the multiple resolution candidates,
identifying a layer, in the second model, which outputs an activation that can be concatenated with the part of activation after size conversion, and
when performing inference, concatenating, in a channel direction, an activation output from the identified layer and the part of activation after size conversion, and inputting concatenation result to a next layer in the second model.
